(19) United States
(12) Patent Application Publication
(10) Pub. No.: US 2009/0205440 A1
(43) Pub. Date: Aug. 20, 2009

(54) Device for indicating and regulating the flow volume in a fluid circuit of a heating or cooling system

(75) Inventor: Fritz SPIESS, Unterlunkhofen (CH)

Correspondence Address: Muncy, Geissler, Olds & Lowe, PLLC, P.O. BOX 1364, FAIRFAX, VA, 22038-1364, US

(73) Assignee: WATTS INDUSTRIES DEUTSCHLAND GESELLSCHAFT MIT BESCHRAENKTER HAFTUNG, Landau (DE)

(21) Appl. No.: 12/328,011

(22) Filed: Dec. 4, 2008

(30) Foreign Application Priority Data
Dec. 5, 2007 (DE) 20 2007 016 961.2

(51) Int. Cl. G01F 1/22; F16K 37/00; F16K 1/38; G05D 7/01

(52) U.S. Cl. 73/861.53; 137/559; 251/321

(57) ABSTRACT

A device for indicating and regulating the flow volume in a fluid circuit of a heating or cooling system is provided. The device includes a housing having a lower valve part, a conical bore, and a sealing seat. The device further includes an indicating element having a hollow-cylindrical inspection glass with a closed end, an open end, an indicator plunger axially movable therein and stressed by means of a spring. A regulating cone is attached to the open end of the inspection glass, whereby the free end of the indicator plunger is guided through the regulating cone and bears a flow body immersed in the conical bore. Also, the regulating cone has slots distributed at the periphery and extending to the indicator plunger.

The invention relates to devices for indicating and regulating the flow volume in a fluid circuit of a heating or cooling system according to the preamble of claim 1. A unit of type is known from German Utility Model No. DE 20 2005 017 577 U.

The device disclosed in said publication has an indicating element and a measuring element, as well as a regulating device, whereby the indicating element comprises a tubular inspection glass which is held in a guide element and at the same time acts as an actuating element for the regulating device and in whose bore an indicator plunger extending inwardly into the measuring tube of the measuring element is guided movable lengthwise. The bore of the inspection glass is widened like a blind hole at its lower end facing the measuring element. A valve head made of an elastic material such as rubber, plastic, or the like is inserted into this widened area. The valve head with its free front face acts directly against the valve seat formed on the end side of the measuring tube.

The valve head has a central attachment piece similar to a truncated cone, which may have a longitudinal rib, whereby said rib may run curved concavely. This enables the fine adjustment of the flow volume.

The valve head has an axial bore, in which the indicator plunger is guided. In this case, said bore can be formed as a guide only over part of its length. In this case, the bore is widened to a polygonal, especially square cross section in the connection to the cylindrical part.

It has become apparent that organic and inorganic material can accumulate in the gap between the valve head and the plunger. As a result, the indicator plunger can no longer move freely, so that the indicated flow volume no longer corresponds to the actual flow volume, which leads to misalignment by the installer. This is unsatisfactory.

The object of the present invention is to provide a device in which such deposits, if not avoided, are nevertheless considerably reduced.

This object is achieved by the device having the feature of claim 1.

Due to the slots, extending up to the indicator plunger, in the regulating cone, the fluid flows preferably through these slots and cleans the gap between the valve head and the indicator plunger because of the increased flow velocity. The fine regulation of the flow volume is retained in a correct design of the valve head and valve seat.

According to an advantageous embodiment of the invention, the regulating cone consists of plastic, particularly a hard plastic.

According to a refinement of the invention, the regulating cone is attached to the inspection glass with use of an elastic molded piece. In this case, the molded piece can consist, for example, of rubber.

As already mentioned, the shape of the slots has an effect on the regulation of the flow volume and flow velocity. According to a refinement of the invention, the slots are made conical or wedge-shaped.

The invention will be described in greater detail in form of the exemplary embodiment with use of the drawing. The figures show the following:

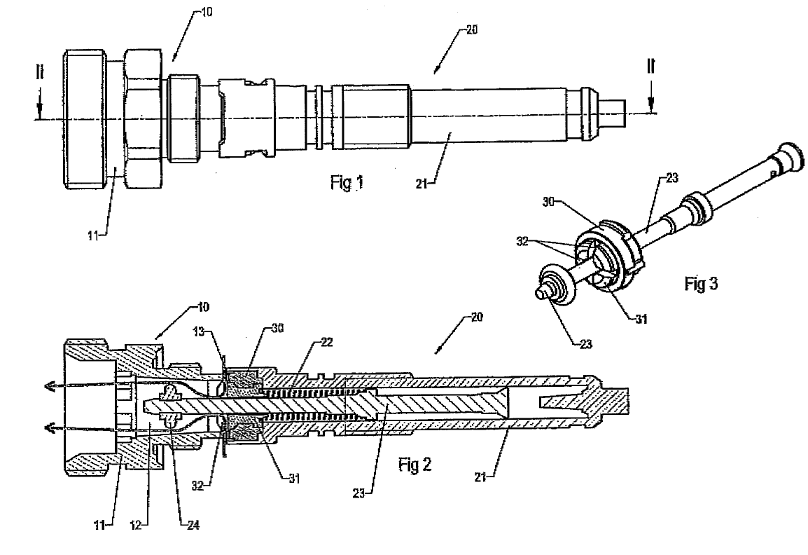

FIG. 1 shows a device for indicating and regulating the flow volume in a fluid circuit as a side view,

FIG. 2 shows a longitudinal section along the line II-II through the device of FIG. 1, and

FIG. 3 shows a perspective view of a valve head and a molded piece.

FIG. 1 as a side view and FIG. 2 as a longitudinal section along the line II-II show a device for indicating and regulating the flow volume in a fluid circuit of a heating or cooling system. A housing 10 with a lower valve part 11, a conical bore 12, and a sealing seat 13 are evident. Furthermore, an indicating element 20 with a hollow-cylindrical inspection glass 21 with a closed end and an open end and with an indicator plunger 23 axially movable therein and stressed by means of spring 22 is evident.

FIG. 2 shows, furthermore, a regulating cone 31 attached at the open end of inspection glass 21 by means of an elastic molded piece 30. The free end of indicator plunger 23 is guided through regulating cone 31 and bears a flow body 24 immersed in conical bore 12.

As is evident from FIG. 2 in section and particularly from FIG. 3, regulating cone 31 has slots 32 distributed at the periphery, which extend up to indicator plunger 23. When regulating cone 31 descends to valve seat 13, the fluid flows preferably into slots 32. In so doing, a rapid flow develops which flushes away deposits in the gap between indicator plunger 23 and regulating cone 31. The amount and rate of the fluid flow effecting the cleaning can be selectively controlled by suitable design of the slots. Due to the reduction or elimination of deposits, indicator plunger 23 remains freely movable, so that the indicated flow volume corresponds to the actual flow volume.

1. A device for indicating and regulating flow volume in a fluid circuit of a heating or cooling system, the device comprising
a housing having
a lower valve part,
a conical bore,
and a sealing seat;
an indicating element having
a hollow-cylindrical inspection glass with
a closed end,
an open end,
and an indicator plunger axially movable therein and stressed by a spring; and
a regulating cone attached to the open end of the inspection glass,
a free end of the indicator plunger being guided through the regulating cone
and bears a flow body immersed in the conical bore,
wherein the regulating cone has slots distributed at the periphery and extending to the indicator plunger.

2. The device according to claim 1, wherein the regulating cone is plastic.

3. The device according to claim 1, wherein the regulating cone is attached to the inspection glass with use of an elastic molded piece.

4. The device according to claim 3, wherein the molded piece is formed of rubber.

5. The device according to claim 1, wherein the slots are conical or wedge-shaped.
